(19) United States
(12) Patent Application Publication
(10) Pub. No.: US 2009/0098254 A1
(43) Pub. Date: Apr. 16, 2009

(54) Methods And Compositions For Improving Sensory And Shelf Life Characteristics Of Raw Meat Products

(76) Inventors: Robert Ty Baublits, Colcord, OK (US); Benedict Thomas Rosario Maresca, Camden, SC (US)

Correspondence Address: MARSHALL, GERSTEIN & BORUN LLP, 233 SOUTH WACKER DRIVE, 6300 SEARS TOWER, CHICAGO, IL, 60606-6357, US

(21) Appl. No.: 11/871,823

(22) Filed: Oct. 12, 2007

(51) Int. Cl. A23B 4/18; A23B 4/10; A23B 4/12

(52) U.S. Cl. 426/92; 426/281; 426/310; 426/541

(57) ABSTRACT

The invention is generally related to methods and compositions for improving sensory and shelf life characteristics of raw meat products. More specifically, the invention relates to meat marinade compositions comprising a plant extract product comprising at least one bioflavonoid compound, and optionally, an organic acid suitable for use on a meat product, methods of making such meat marinade compositions, and methods of treating raw meat products with same.

### FIELD OF THE INVENTION

The invention is generally related to methods and compositions for improving sensory and shelf life characteristics of meat products. More specifically, the invention relates to meat marinade compositions comprising a plant extract product comprising at least one bioflavonoid compound, and optionally further comprising an organic acid suitable for use on a meat product, methods of making such meat marinade compositions, and methods of treating meat products with same.

### BACKGROUND OF THE INVENTION

Meat products are highly perishable due to their high moisture and protein contents. For example, cuts of meat contain bacteria on their surfaces that will ultimately (i.e., over time) cause the meat to spoil. Ground raw meat products are more susceptible to spoilage due to their increased surface area and the steps involved in producing ground raw meat products. Both cooked and raw meat products and ready to eat meat products (such as deli meats) also have limited shelf-lives. Consumption of spoiled meat products can cause consumers to become ill. Further, spoiled meat products cause food purveyors to sustain substantial economic losses.

Numerous technologies have therefore been developed to delay spoilage or extend the shelf life of meat products. For example, raw meat products have been treated with radiation in order to reduce spoilage and thus extend shelf-life. Many consumers do not approve of radiation treatments, however, and thus other solutions are desired.

Meat products are often treated with marinades containing phosphates including but not limited to sodium tripolyphosphate (STP) and salts including but not limited to sodium chloride. Some consumers, however, prefer “all natural” meat products, which must be free of added artificial ingredients such as phosphates. Thus, meat products cannot be treated with traditional phosphate-containing marinades and subsequently labeled or otherwise advertised as “all natural.” Furthermore, such marinades do not provide significant anti-microbial properties to the treated meat products.

Optimization of the meat product packaging and/or its surrounding atmosphere has also been applied to inhibit spoilage. An exemplary type of packaging is generally known as a “tray-type package.” A tray-type package includes a tray made from polystyrene or other suitable material. The meat product to be packaged is placed in the tray and then a sealing film material is sealed over a top opening of the tray to form a sealed package containing the meat product. Various inert gases such as carbon dioxide, nitrogen, and/or argon can be introduced during the packaging process so as to enrich the meat product package atmosphere with inert gas. This helps to maintain an anaerobic environment in the sealed package, which is useful for inhibiting aerobic microbial growth and accompanying spoilage of the packaged meat product. Additionally, other gases such as oxygen and carbon monoxide have been found to be effective in maintaining the red color in certain raw meat products. Packaging that includes a modified atmosphere surrounding the meat product is commonly referred to as “modified atmosphere packaging.”

Modified atmosphere packaging can also include films which are impermeable to oxygen. Films that are impermeable to oxygen similarly extend the shelf life of meat products by inhibiting aerobic microbial growth and accompanying spoilage of the packaged meat product. Unfortunately, the use of various of the aforementioned technologies can cause a meat product to have a visible appearance that continues to suggest that the meat product has not spoiled even when its microbial counts are unacceptably high. Thus, such technologies can cause the sensory characteristics of a meat product to be successfully maintained even when its shelf life has expired.

### SUMMARY OF THE INVENTION

The invention provides marinade compositions which safely extend the shelf life of a meat product. Specifically, the invention provides compositions which, when applied to a meat product, enhance its sensory characteristics (e.g., the appearance of the meat product) while similarly enhancing its shelf life (e.g., inhibiting bacterial growth). Thus, the color change associated with spoilage of meat products is not simply masked by treating meat products with marinades in accordance with the invention. Rather, demonstrable reductions in bacterial growth are achieved while the color change is simultaneously inhibited at a similar rate.

In one embodiment, the invention provides a meat product marinade comprising at least one plant extract product, said plant extract product comprising at least one bioflavonoid compound, said meat product marinade optionally further comprising at least one organic acid suitable for use on a meat product. Often, the marinades are applied to raw meat products, but they could also be applied to cooked meat products.

In another embodiment, the invention provides a method of making a meat product marinade comprising providing a vessel and mixing at least one plant extract product and a solvent in said vessel, wherein said plant extract product comprises at least one bioflavonoid compound.

In yet another embodiment, a method of treating a meat product comprises providing a meat portion, providing a marinade comprising at least one plant extract product, said plant extract product comprising at least one bioflavonoid compound, said meat product marinade optionally further comprising at least one organic acid suitable for use on a meat product, and contacting the meat portion with the marinade.

In a further embodiment, a marinated raw meat product comprises a meat portion having a surface thereof treated with a marinade comprising at least one plant extract product comprising at least one bioflavonoid compound, said meat product marinade optionally further comprising at least one organic acid suitable for use on a meat product.

### DETAILED DESCRIPTION OF THE INVENTION

The invention provides marinade compositions which are capable of safely extending the shelf life of meat products. The marinade compositions beneficially enhance the sensory characteristics of meat products (e.g., the color of a case ready raw meat product) while similarly enhancing the shelf life of the meat products. Without intending to be bound by theory, it is believed that the marinade compositions prevent oxidation of the meat products while simultaneously causing damage to the pathogenic microbes associated with the meat products, thereby preventing additional microbial growth and/or lowering the amount of existing colony forming units (cfus) present in the meat product. Furthermore, in some instances, consumers have exhibited statistically significant preferences for the texture of cooked meat products which were treated in accordance with the invention. Additionally, in some instances, raw meat products treated in accordance with the invention exhibit statistically significant improved instrumental color after said meat products have been stored for a period of time. Instrumental color can be determined using a instrumental calorimeter as known in the meat product industry.

The meat product marinade compositions comprise at least one plant extract product, and optionally, at least one organic acid suitable for use on a meat product. The plant extract product generally comprises at least one bioflavonoid compound.

In one aspect, the marinade compositions are all natural, i.e., the meat product marinades contain only ingredients which are classified as natural ingredients according to U.S. Department of Agriculture (U.S.D.A.) standards, e.g., the meat marinades do not contain any artificial flavors (or flavorings), artificial coloring ingredients, or chemical preservatives (e.g., as defined in 21 C.F.R. §101.22). Thus, in one aspect, the marinades are free of artificial flavors, artificial colors, and phosphate compounds.

The meat marinades can be applied to any type of meat including but not limited to beef (including veal), poultry (including chicken and turkey), pork, goat, fish, and lamb. As used herein, the terms “meat,” “meat portion,” and “meat product” may be used interchangeably and generally refer to cuts of meat which are offered to the wholesale and/or retail buying public. The meat portion can be any meat portion including but not limited to a fresh or raw meat portion, a previously frozen meat portion, a partially cooked meat portion, a fully cooked meat portion, or a cured meat portion. Thus, the nature of the meat portion is generally not significant to the improvements imparted by the meat marinades. The meat portion can be a whole animal (e.g., a whole chicken or turkey), a chicken quarter, a breast, a thigh, a wing, a tender, a drumstick, a tenderloin, a strip loin, a chop (e.g., a pork chop), or any other meat portion (or cut of meat).

The invention also provides a method of making a meat product marinade. Typically, at least one plant extract product comprising at least one bioflavonoid compound is added to a solvent vehicle under mixing. At least one organic acid suitable for use on a meat product may optionally be further included.

Typically, the solvent vehicle comprises an aqueous solvent system, but other solvents may be employed. In one exemplary embodiment, the meat marinade solvent system is selected from non-toxic solvents including but not limited to water, ethanol, glycerine, and combinations thereof. Other non-toxic solvents that are safe for human and/or animal ingestion could also be used. Generally, at least one solvent is present in the marinade compositions in an amount from about 35 to about 97 weight percent (“wt.%”), about 50 to about 95 wt.%, and/or about 65 to about 90 wt.%. When a component is described with the unit “wt.%,” it should be generally understood that content is determined relative to the total weight of the composition unless otherwise stated.

Any organic acid suitable for use on a meat product and/or the salts thereof may be used in the meat product marinade compositions. The organic acids (and their salts) must be safe for human and/or other animal consumption. The organic acid may be selected from various carboxylic acids, for example, carboxylic acids having from 1 to 18 carbon atoms, straight chain or branched. For example, the organic acids may be derived from sugar moieties. Suitable organic acids derived from sugar moieties include but are not limited to gluconic acid, mannonic acid, glucoheptanoic, malic acid, propionic acid, and galactonic acid. Suitable organic acids selected from carboxylic acids having from 1 to 18 carbon atoms include but are not limited to formic acid, acetic acid, ascorbic acid, citric acid, heptanoic acid, adipic acid, and tartaric acid. Citric acid and/or ascorbic acid (including the salts thereof) are generally preferred for palatability and performance reasons (e.g., to enhance sensory characteristics, or to enhance antimicrobial and/or antioxidant effects). Generally, the organic acid is present in the marinade compositions in an amount from about 0.01 to about 35 weight percent (“wt.%”), about 0.05 to about 30 wt.%, about 0.25 to about 20 wt.%, and/or about 0.50 to about 5 wt.%.

Any plant extract product comprising at least one bioflavonoid compound may be used in the meat product marinade compositions. As used herein, the term “plant extract product” refers to any compound, any agent and/or mixtures thereof, that is obtained, isolated, and/or derived from an extract of a plant material. The term “plant material” refers to any plant material including, but not limited to, leaves, stems, flowers, fruits, seeds, roots, and combinations thereof. Fruits, when available, are typically used to produce the extract products.

Suitable bioflavonoid compounds generally comprise a phenyl moiety coupled to a benzopyrone moiety, e.g., 2-phenylchromen-4-one (2-phenyl-1,4-benzopyrone), 3-phenylchromen-4-one (3-phenyl-1,4-benzopyrone),and 4-phenylcoumarin (4-phenyl-1,2-benzopyrone). Derivatives suitable for use in the meat product marinades include compounds wherein the carbon-carbon double bond and/or the keto of the benzopyrone is reduced, and/or where the various carbon atoms have been hydroxylated and/or coupled to a sugar moiety. Accordingly, as used herein, the term bioflavonoid includes bioflavonoid compounds and its derivatives. Suitable bioflavonoids include but are not limited to flavones, flavonols, flavanones, isoflavones, flavan-3-ols, and anthocyandins. Representative bioflavanoid compounds include but are not limited to Luteolin, Apigenin, Tangeritin, Rhoifolin, Neodiosmin, Quercetin, Kaempferol, Myricetin, Fisetin, Isorhamnetin, Pachypodol, Rhamnazin, Hesperetin, Neohesperetin, Naringenin, Eriodictyol, Hesperedin, Neohesperedin, Neoeriocitrin, Isonarinagin, Naringin, Poncirin, Dihydroquercetin, Dihydrokaempferol, Genistein, Daidzein, Glycitein, Catechins such as Catechin (C), Gallocatechin (GC), Catechin 3-gallate (Cg), and Gallocatechin 3-gallate (GCg), Epicatechins such as Epicatechin (EC), Epigallocatechin (EGC), Epicatechin 3-gallate (ECg), and Epigallocatechin 3-gallate (EGCg), Cyanidin, Delphinidin, Malvidin, Pelargonidin, Peonidin, Petunidin, Rutin, Pycnogenol, and mixtures thereof. Generally, the at least one bioflavonoid compound is present in the marinade compositions in an amount from about 0.001 to about 7.5 wt.%, about 0.01 to about 5 wt.%, and/or about 0.25 to about 2.5 wt.%. Accordingly, the plant extract product is contained in an amount sufficient to provide the foregoing bioflavonoid concentrations.

Suitable plant extract products comprising at least one bioflavonoid compound can be obtained from a variety of plants including but not limited to orange trees, grapefruit trees, lime trees, lemon trees, tangerine trees, grape vines, cocoa plants, plum trees, raspberry plants, blackberry plants, red onions, yellow onions, shallots, walnut trees, pecan trees, tomato plants, green tea plants, black tea plants, bilberry, gingko, pine trees, yarrow, hawthorn trees, hazel trees, olive trees, rose bushes, Echinacea, golden seal, and soy plants. Plant extract products derived from rosemary are specifically excluded as being suitable for use as plant extract products comprising at least one bioflavonoid in accordance with the marinade compositions of the invention.

In one preferred embodiment, the plant extract product is extracted from at least one citrus plant material, for example, orange fruit. Other suitable citrus fruits may also be used (alone or in combination with each other) including but not limited to grapefruits, limes, tangerines, and/or lemons. Suitable commercially available plant extract products comprising bioflavonoids include orange extracts, Echinacea extracts, green tea extracts, and the like (Esco Foods, Calif.; Alchem Industries, India; The Arnhem Group, N.J.). Other suitable commercially available plant extract products (including those prepared from citrus fruits) comprising numerous bioflavonoid compounds are Flavonoid Plus™ (The Arnhem Group, N.J.) and Citrus Bioflavonoids Complex, 45% HPLC grade (Ferrer Group, Zoster, S. A., Spain). Other similar commercially available products comprising mixtures of bioflavonoid compounds, particularly bioflavonoid compounds derived from citrus fruits, may also be used in the meat product marinade compositions according to the invention. In one aspect, the plant extract product may be substantially free of rosemarinic acid, for example, it may contain less than two weight percent rosemarinic acid.

Alternatively, instead of using a commercially available source of bioflavonoids, plant extract products comprising at least one bioflavonoid compound can be prepared using extraction methods known in the art. An exemplary extraction method for obtaining bioflavonoid compounds from plant materials comprises the following steps: (1) providing fresh or fresh-frozen plant material; (2) disrupting the plant material; (3) extracting the plant material in a solution containing a sufficient amount of solvent; and (4) isolating the obtained extract. The extract may be further processed by: (5) removing solid matter from the extract; (6) removing solvent components (e.g., by vacuum drying); (7) resuspending the resulting residue in an aqueous solution; and (8) after removing any water insoluble material, repeating step (6) to form a more purified form of an extract product. In various embodiments, the plant material can be disrupted by macerating, grinding, or otherwise disrupting the plant material.

In a preferred embodiment, fresh plant tissue is quick-frozen in liquid nitrogen, then ground or otherwise macerated (e.g., using a blender) in solvent. After solids are removed from the extract, e.g., by filtration, centrifugation, or any method known in the art, the content of the bioflavonoid compounds in the extract can optionally be measured by any known method, including spectrometric methods.

Solvents for use in the extraction methods include well-known solvents such as, but not limited to, water, alcohols, glycols, alkanes, halocarbons, ethers, aromatic solvents, ketones, aqueous solvents, esters, and super critical fluids. In one embodiment, ethanol and/or glycerine are preferred solvents for practice of the invention. A benefit of incorporating ethanol and/or glycerine in the final extraction step is that these solvents are compatible with an ingestible product, and therefore suitable for incorporation into the final marinade compositions. Otherwise, the solvents may be removed as is well known.

The meat marinades can be applied to partially or fully cooked meat products, but typically the meat marinades are applied to raw or fresh meat products. In one aspect, cured meat products such as hams and sausages are specifically excluded from the meat products which are treated in accordance with the invention.

The marinade compositions can be applied to raw meat products during the preparation of case ready raw meat products. The term “case ready raw meat product” is used consistently with its meaning within the meat product industry, and refers to a meat product that is enhanced (by processing in some way) at a central location and then shipped from that location. In one aspect, a case ready meat product is packaged in a processing plant such that the need for further handling, cutting, or other processing at the retail store level is substantially or entirely eliminated.

The marinades can be applied to the meat products, for example, by injection. Alternatively, the marinades can be applied to the meat products by coating, soaking, spraying, basting, blanching, flowing, submerging, pressure infusing, or tumbling the marinade to the meat portion. Suitable application methods and apparatus for same are well known to those of ordinary skill in the art. Generally, the marinades are applied to the meat products by spraying or misting and/or injection. Typically, the meat products include about 0.25 wt.% to about 50 wt.%, about 0.5 wt.% to about 30 wt.%, 2 wt.% to about 20 wt.%, and/or about 5 to about 15 wt.%, based on the weight of the meat product prior to addition of the marinade. Topical application is used to treat ground meat products, but can also be used to treat cuts or portions of meat. Injection is used to treat meat portions or cuts of meat, particularly meat portions that are intended to be packaged for retail sale (including case ready meat products).

In certain embodiments, it may be desirable to inject a meat portion and then subsequently spray the same marinade composition onto its outer surface. In other embodiments, for example, when red meat products are being treated, it may be desirable to spray a solution comprising an organic acid onto the meat product before or after the marinade composition in accordance with the invention is injected into or otherwise applied to same. For example, it may be beneficial to spray the meat product with a solution comprising from about 5 wt.% to about 20 wt.% ascorbic acid, or a solution comprising from about 5 wt.% to about 20 wt.% citric acid.

The meat marinade may optionally include one or more additives, for example, to enhance palatability and/or anti-microbial properties. For example, the marinades can contain additional ingredients such as poultry broth (e.g., turkey broth and/or chicken broth), beef broth, beef tallow (including encapsulated beef tallow), pork lard (including encapsulated pork lard), pork broth, chicken powder, natural flavorings (e.g., as defined in 9 C.F.R. §317.2) including but not limited to herbs, herb extracts such as rosemary extracts, spices, fruit extracts, vegetable extracts, and natural sweeteners, artificial flavorings, and mixtures thereof. In one aspect, the meat marinades contain only ingredients which are classified as natural ingredients according to U.S. Department of Agriculture (U.S.D.A.) standards, e.g., the meat marinades do not contain any artificial flavors (or flavorings), artificial coloring ingredients, or chemical preservatives (e.g., as defined in 21 C.F.R. §101.22). In another aspect, the meat marinades are free of added phosphates, which are classified as artificial ingredients under the referenced standard. Of course, in other embodiments, the meat marinades may comprise phosphate-based preservatives. Other suitable additives include but are not limited to salts, for example, sodium chloride and potassium chloride, and cultured corn syrup solids.

Exemplary citric-acid based marinade typically comprise about 0.5 to about 35 wt.% citric acid, about 0.1 to about 10 wt.% of at least one bioflavonoid compound, about 0.25 to about 20 wt.% glycerine, and about 40 to about 95 wt.% water. For example, a citric-acid based marinade comprising about 20 to about 30 wt.% citric acid, about 2 to about 5 wt.% of at least one bioflavonoid compound, about 10 to about 15 wt.% glycerine, and about 50 to about 60 wt.% water can be used for topical application. Additionally, a citric-acid based marinade comprising about 1 to about 3 wt.% citric acid (for example, about 2 wt.%), about 0.1 to about 0.5 wt.% of at least one bioflavonoid compound (for example, about 0.3 wt.%), about 0.05 to about 4 wt.% glycerine (for example, about 1 wt.%), and about 80 to about 95 wt.% water can be used for injection application. The foregoing marinades may also comprise salt and/or phosphates to enhance flavor and/or preservative properties, as previously described. Typically, when included, salts are present in an amount from about 0.1 to about 5 wt.% (for example, about 3.5 wt.%) and phosphates in an amount from about 0.1 to about 6 wt.% (for example, about 4 wt.%).

Exemplary ascorbic-acid based marinades typically comprise about 0.025 to about 15 wt.% ascorbic acid, about 0.01 to about 5 wt.% of at least one bioflavonoid compound, about 0.05 to about 25 wt.% glycerine, and about 40 to about 95 wt.% water. For example, an ascorbic-acid based marinade comprising about 5 to about 15 wt.% ascorbic acid (for example, about 10 wt.%), about 1.5 to about 5 wt.% of at least one bioflavonoid compound (for example, about 2.25 wt.%), about 5 to about 25 wt.% glycerine (for example, about 15 wt.%), and about 60 to about 80 wt.% water (for example, about 70 wt.%)can be used for topical application. Additionally, an ascorbic-acid based marinade comprising about 0.05 to about 0.5 wt.% ascorbic acid (for example, about 0.1 wt.%), about 0.01 to about 0.5 wt.% of at least one bioflavonoid compound (for example, about 0.025 wt.%), about 0.05 to about 4 wt.% glycerine (for example, about 0.15 wt.%), and about 80 to about 95 wt.% water (for example, about 90 wt.%) can be used for injection application. The foregoing marinades may also comprise salt and/or phosphates to enhance flavor and/or preservative properties, as previously described. Typically, when included, salts are present in an amount from about 0.1 to about 5 wt.% (for example, about 3.5 wt.%) and phosphates in an amount from about 0.1 to about 6 wt.% (for example, about 3 wt.%).

The foregoing description has been given for clearness of understanding only, and thus no unnecessary limitations should be understood therefrom, as modifications within the scope of the invention are expected to occur to those having ordinary skill in the art.

What is claimed:

1. A meat product marinade comprising at least one organic acid suitable for use on a meat product and at least one plant extract product, said plant extract product comprising at least one bioflavonoid compound.

2. The meat product marinade according to claim 1, further comprising at least one solvent.

3. The meat product marinade according to claim 1, wherein the solvent is selected from the group consisting of water, ethanol, glycerine, and combinations thereof.

4. The meat product marinade according to claim 1, wherein the organic acid is selected from the group consisting of carboxylic acids having from 1 to 18 carbon atoms.

5. The meat product marinade according to claim 1, wherein the organic acid is derived from sugar moieties.

6. The meat product marinade according to claim 1, wherein the organic acid is selected from the group consisting of gluconic acid, mannonic acid, glucoheptanoic, galactonic acid, formic acid, acetic acid, ascorbic acid, citric acid, heptanoic acid, adipic acid, and tartaric acid.

7. The meat product marinade according to claim 1, wherein the organic acid is present in an amount from about 0.01 to about 35 weight percent

8. The meat product marinade according to claim 1, wherein the bioflavonoid compound is selected from the group consisting of flavones, flavonols, flavanones, isoflavones, flavan-3-ols, and anthocyandins.

9. The meat product marinade according to claim 1, wherein the bioflavonoid compound is selected from the group consisting of Luteolin, Apigenin, Tangeritin, Rhoifolin, Neodiosmin, Quercetin, Kaempferol, Myricetin, Fisetin, Isorhamnetin, Pachypodol, Rhamnazin, Hesperetin, Neohesperetin, Naringenin, Eriodictyol, Hesperedin, Neohesperedin, Neoeriocitrin, Isonarinagin, Naringin, Poncirin, Dihydroquercetin, Dihydrokaempferol, Genistein, Daidzein, Glycitein, Catechins such as Catechin (C), Gallocatechin (GC), Catechin 3-gallate (Cg), and Gallocatechin 3-gallate (GCg), Epicatechins such as Epicatechin (EC), Epigallocatechin (EGC), Epicatechin 3-gallate (ECg), and Epigallocatechin 3-gallate (EGCg), Cyanidin, Delphinidin, Malvidin, Pelargonidin, Peonidin, Petunidin, Rutin, Pycnogenol, and mixtures thereof.

10. The meat product marinade according to claim 1, wherein the bioflavonoid compound is present in an amount from about 0.01 to about 5 wt.%.

11. The meat product marinade according to claim 1, wherein the bioflavonoid compound is derived from a plant selected from the group consisting of orange trees, grapefruit trees, lime trees, lemon trees, tangerine trees, grape vines, cocoa plants, plum trees, raspberry plants, blackberry plants, red onions, yellow onions, shallots, walnut trees, pecan trees, tomato plants, green tea plants, black tea plants, bilberry, gingko, pine trees, yarrow, hawthorn trees, hazel trees, Echinacea, golden seal, soy plants, and combinations thereof, and wherein the bioflavonoid compound is not derived from rosemary.

12. A method of making a meat product marinade comprising providing a vessel and mixing at least one organic acid and at least one plant extract product in said vessel, wherein said plant extract product comprises at least one bioflavonoid compound.

13. A method of treating a meat product comprises providing a meat portion, providing a marinade comprising at least one organic acid suitable for use on a meat product and at least one plant extract product, said plant extract product comprising at least one bioflavonoid compound, and contacting the meat portion with the marinade.

14. The method according to claim 13, further comprising spraying an acidic solution on the meat product after said meat product has been contacted with the marinade.

15. The method according to claim 13, wherein the contacting is accomplished by injection, coating, soaking, spraying, basting, blanching, flowing, submerging, pressure infusing, or tumbling.

16. The method according to claim 14, wherein the acidic solution comprises ascorbic acid, citric acid, or combinations thereof.

17. A meat portion having a surface thereof treated with a marinade composition according to claim 1.

18. The meat portion according to claim 17, wherein the meat is selected from beef, poultry, pork, goat, fish, and lamb.

19. The meat portion according to claim 17, wherein the organic acid is selected from ascorbic acid, citric acid, and combinations thereof.

20. The meat portion according to claim 19, wherein the plant extract product is obtained from citrus plant materials.

21. The meat portion according to claim 20, wherein the citrus plant materials comprise citrus fruits.
